(19) United States
(12) Patent Application Publication
(10) Pub. No.: US 2019/0176641 A1
(43) Pub. Date: Jun. 13, 2019

(54) METHOD FOR CHARGING BATTERY OF ELECTRIC VEHICLE

(71) Applicants: HYUNDAI MOTOR COMPANY, SEOUL (KR); KIA MOTORS CORPORATION, SEOUL (KR)

(72) Inventors: Ki Seung BAEK, Yangsan-si (KR); Do Sung HWANG, Gunpo-si (KR)

(73) Assignees: HYUNDAI MOTOR COMPANY, SEOUL (KR); KIA MOTORS CORPORATION, SEOUL (KR)

(21) Appl. No.: 15/978,623

(22) Filed: May 14, 2018

(30) Foreign Application Priority Data
Dec. 11, 2017 (KR) 10-2017-0169217

(51) Int. Cl. B60L 11/18

(52) U.S. Cl. CPC B60L 11/1862; B60L 11/1818

(57) ABSTRACT

The present disclosure provides methods for charging a battery of an electric vehicle, which relates to a technology for preventing deterioration of a battery embedded in an electric vehicle while simultaneously improving a charging speed of the battery. The battery charging method includes dividing a total State of Charge (SOC) section of a battery into a plurality of steps, and performing constant current based charging in each of the plurality of steps, and performing constant voltage-based charging at a predetermined voltage during the constant current based charging for each step of the plurality of steps.

### CROSS-REFERENCE TO RELATED APPLICATION

The present application claims priority to and the benefit of Korean Patent Application No. 10-2017-0169217, filed on Dec. 11, 2017, which is incorporated herein by reference in its entirety.

### FIELD

Forms of the present disclosure relate to an electric vehicle, and more particularly to a method for charging a battery of an electric vehicle.

### BACKGROUND

The statements in this section merely provide background information related to the present disclosure and may not constitute prior art.

In general, a vehicle is a machine which travels on roads or tracks using fossil fuels, electricity, etc.

A vehicle driven using fossil fuels may discharge fine dust, water vapour, carbon dioxide (CO₂), carbon monoxide (CO), hydrocarbon, nitrogen (N), nitrogen oxide, and/or sulfur oxides, etc. due to burning of fossil fuels. Water vapour and carbon dioxide (CO₂) have been known to cause global warming, and fine dust, carbon monoxide (CO), hydrocarbon, nitrogen oxide, and/or sulfur oxide, etc. have been known as air pollution materials that cause harm to people.

Due to the above issues, eco-friendly vehicles driven using eco-friendly energy instead of fossil fuels have recently been developed and rapidly come into widespread use. For example, many developers and companies are conducting intensive research into hybrid electric vehicles (HEVs) driven using fossil fuels and electricity and electric vehicles (EVs) driven only using electricity.

Each of the hybrid electric vehicle (HEV) and the electric vehicle (EV) may include a high-voltage battery for supplying power to a motor used to move the vehicle and a low-voltage battery for supplying power to electronic components embedded in the vehicle. Generally, each of the hybrid electric vehicle (HEV) and the electric vehicle (EV) may include a power-supply device for converting a voltage of the high-voltage battery into a voltage of the low-voltage battery so as to supply power from the high-voltage battery to the low-voltage battery.

### SUMMARY

Therefore, it is an aspect of the present disclosure to provide a technology for preventing deterioration of a battery embedded in an electric vehicle while simultaneously improving a charging speed of the battery.

Additional aspects of the disclosure will be set forth in part in the description which follows and, in part, will be obvious from the description, or may be learned by practice of the disclosure.

In accordance with an aspect of the present disclosure, a battery charging method includes: dividing a total State of Charge (SOC) section of a battery into a plurality of steps, and performing constant current based charging in each step of the plurality of steps; and performing constant voltage based charging at a predetermined voltage during the constant current based charging for each step of the plurality of steps.

The battery charging method may further include: measuring a voltage of the battery; and determining a charge start step among the plurality of steps based on the voltage of the battery.

The constant current based charging for each step of the plurality of steps may be configured to follow a constant current instruction corresponding to a corresponding step.

The battery charging method may further include: when a voltage of the battery charged by the constant current based charging arrives at a predetermined voltage, changing a battery charging scheme to a constant voltage based charging scheme.

The battery charging method may further include: when the battery charging scheme is changed to the constant voltage based charging scheme, determining a deceleration of the constant current instruction in response to a voltage acceleration of the battery based on a constant current based charging scheme.

The predetermined voltage may be lower than a cutoff voltage of each step of the plurality of steps.

The battery charging method may further include dividing the plurality of steps based on the cutoff voltage of the battery.

The predetermined voltage may be a voltage corresponding to a predetermined cutoff SOC of the battery.

The battery charging method may further include: when a charge current of the battery charged at a current step among the plurality of steps drops to a target charge current value of a subsequent step, charging at the subsequent step.

In accordance with another aspect of the present disclosure, an electric vehicle includes: a motor; a battery configured to store power to drive the motor; and a controller configured to divide a total State of Charge (SOC) section of the battery into a plurality of steps, perform constant current based charging in each step of the plurality of steps, and perform constant voltage based charging at a predetermined voltage during the constant current based charging for each step of the plurality of steps.

The controller may be configured to measure a voltage of the battery, and may determine a charge start step among the plurality of steps based on the voltage of the battery.

The constant current based charging for each step of the plurality of steps may be configured to follow a constant current instruction corresponding to a corresponding step.

When a voltage of the battery charged by the constant current based charging arrives at a predetermined voltage, the controller may change a battery charging scheme to a constant voltage based charging scheme.

When the battery charging scheme is changed to the constant voltage based charging scheme, the controller may determine a deceleration of the constant current instruction in response to a voltage acceleration of the battery based on a constant current based charging scheme.

The predetermined voltage may be lower than a cutoff voltage of each step of the plurality of steps.

The controller may divide the plurality of steps based on the cutoff voltage of the battery.

The predetermined voltage may be a voltage corresponding to a predetermined cutoff SOC of the battery.

When a charge current of the battery charged at a current step among the plurality of steps drops to a target charge current value of a subsequent step, the controller may charge at the subsequent step.

In accordance with another aspect of the present disclosure, a battery charging method includes: measuring a voltage of a battery; dividing a total State of Charge (SOC) section of the battery into a plurality of steps, performing constant current based charging in each step of the plurality of steps, and determining a charge start step among the plurality of steps based on the voltage of the battery; performing constant voltage based charging at a predetermined voltage during the constant current based charging for each step of the plurality of steps; and when a charge current of the battery charged at a current step among the plurality of steps drops to a target charge current value of a subsequent step, charging at the subsequent step.

In accordance with another aspect of the present disclosure, a battery charging method includes: measuring a voltage of a battery; dividing a total State of Charge (SOC) section of the battery into a plurality of steps based on a cutoff voltage of the battery, performing constant current based charging in each step of the plurality of steps, determining a charge start step among the plurality of steps based on the voltage of the battery; performing constant voltage based charging at a voltage corresponding to a predetermined cutoff SOC of the battery during the constant current based charging for each step of the plurality of steps; and when a charge current of the battery charged at a current step among the plurality of steps drops to a target charge current value of a subsequent step, charging at the subsequent step.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating the appearance of an electric vehicle;

FIG. 2 is a block diagram illustrating a power system of an electric vehicle;

FIG. 3 is a view illustrating a charge current profile of an electric vehicle;

FIG. 4 is a flowchart illustrating a method for charging a battery of an electric vehicle; FIG. 5 is a table illustrating the relationship between a per-step constant current and a per-step cutoff voltage for charging a high-voltage battery of an electric vehicle;

FIG. 6 is a view illustrating a normal constant-voltage charge control and an abnormal constant-voltage charge control;

FIG. 7 is a table illustrating the relationship between an increase speed of a cell voltage and a reduction speed of a charge current instruction; and

FIG. 8 is a graph illustrating a method for determining a reduction speed of a charge current instruction in response to an increase speed of the cell voltage using the method for charging a high-voltage battery.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference will now be made in detail to the forms of the present disclosure, examples of which are illustrated in the accompanying drawings, wherein like reference numerals refer to like elements throughout.

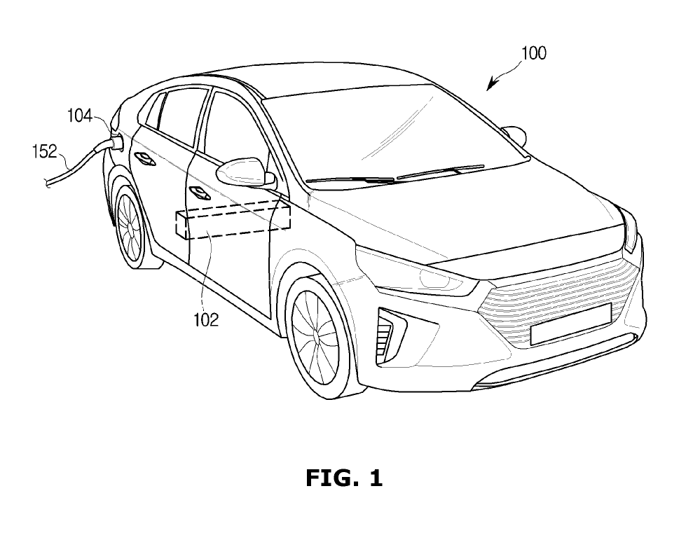

FIG. 1 is a view illustrating the appearance of an electric vehicle 100 in some forms of the present disclosure.

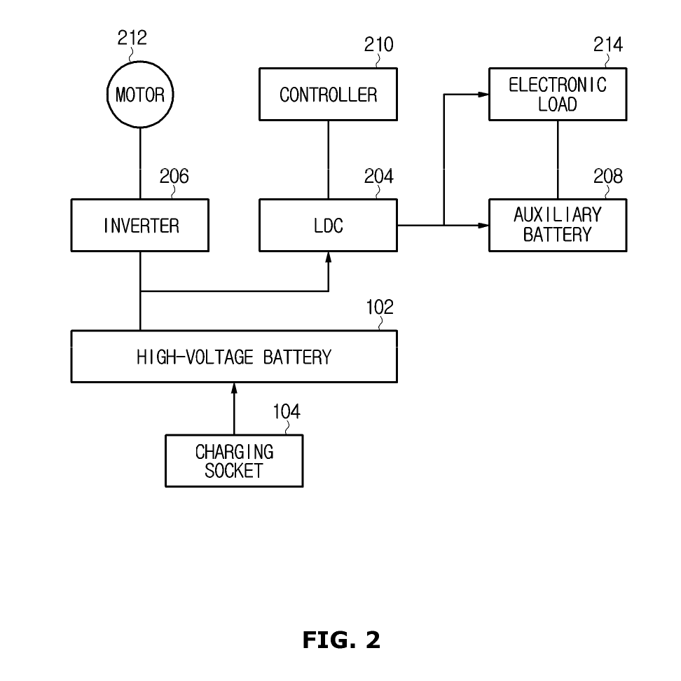

Referring to FIG. 1, the electric vehicle 100 may include a motor 212 (see FIG. 2). Therefore, the electric vehicle 100 may further include a high-voltage battery 102 configured to store power to be used for driving the motor 212. An auxiliary battery 208 (see FIG. 2) may also be provided to a general internal combustion vehicle. However, a large-sized high-capacity high-voltage battery 212 is needed for the electric vehicle 100 whereas an auxiliary battery 208 (see FIG. 2) is provided at one side of an engine compartment of a general internal combustion vehicle. In the electric vehicle 100 in some forms of the present disclosure, a battery 102 is installed at a lower space of a rear passenger seat. Power stored in the battery 102 may be used to generate power by driving the motor 212 (see FIG. 2). The battery 102 in some forms of the present disclosure may be a lithium battery.

The electric vehicle 100 may be equipped with a charging socket 104 acting as a charging inlet. A charging connector 152 of an external charging station may be connected to the charging socket 104, such that the high-voltage battery 102 can be charged with electricity or power. That is, when the charging connector 152 of the charging station is connected to the charging socket 104 of the electric vehicle 100, the high-voltage battery 102 of the electric vehicle 100 can be charged with electricity or power.

FIG. 2 is a block diagram illustrating a power system of an electric vehicle in some forms of the present disclosure. The power system shown in FIG. 2 may be configured to supply power to a motor 212 and electric loads 214.

Referring to FIG. 2, the power system of the electric vehicle 100 in some forms of the present disclosure may include a high-voltage battery 102, a low-voltage DC-DC converter (LDC) 204, an inverter 206, an auxiliary 208, and a controller 210.

The LDC 204 may convert a high DC voltage received from the high-voltage battery 102 into a lower-voltage direct current (DC). The LDC 204 may convert a high DC voltage of the high-voltage battery 102 into an alternating current (AC), may step up (boost) the alternating current (AC) using a coils, a transformer, a capacitor, etc., may rectify the boosted AC, and may then convert the rectified AC into a lower-voltage direct current (DC). The direct voltage (DC) boosted by the LDC 204 may be supplied to individual electronic loads 214 requesting a low voltage.

The DC voltage of the high-voltage battery 102 may be converted into an AC voltage having a predetermined phase and frequency through an inverter 206, such that the resultant AC voltage may be supplied to the motor 212. A rotational force and speed of the motor 212 may be decided by an output voltage of the inverter 206. The controller 210 may control overall operation of a power supply device. In this case, the controller 210 may be a Battery Management System (BMS) for controlling the high-voltage battery 102.

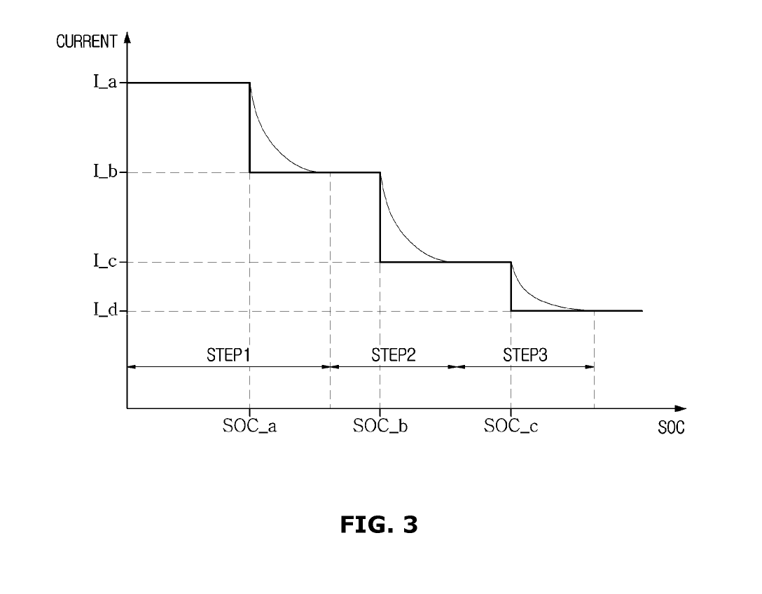

FIG. 3 is a view illustrating a charge current profile of an electric vehicle in some forms of the present disclosure.

Referring to FIG. 3, charging of the high-voltage battery 102 of the electric vehicle 100 in some forms of the present disclosure may be implemented using a combination of a Multi-Step Constant Current (MSCC or MCC) scheme and a Constant Current-Constant Voltage (CC-CV) scheme.

The controller 210 of the electric vehicle 100 may divide a total step (section) of a State Of Charge (SOC) on the basis of a cutoff voltage of the high-voltage battery 102 into a plurality of steps (sections), and may thus charge the battery of the electric vehicle 100 using the MSCC (or MCC) scheme. In each of the steps, the controller 210 may perform charging based on a constant voltage (hereinafter referred to as constant voltage based charging) using a voltage corresponding to a predetermined cutoff SOC. In other words, the controller 210 may perform constant voltage based charging during a constant current charging time per step. The controller 210 may perform charging at a subsequent step when the charge current drops to a target charge current of the subsequent step by current-step charging.

Referring to FIG. 3, the charge SOCs based on the cutoff voltages of the respective steps may include SOC_a, SOC_b, and SOC_c.

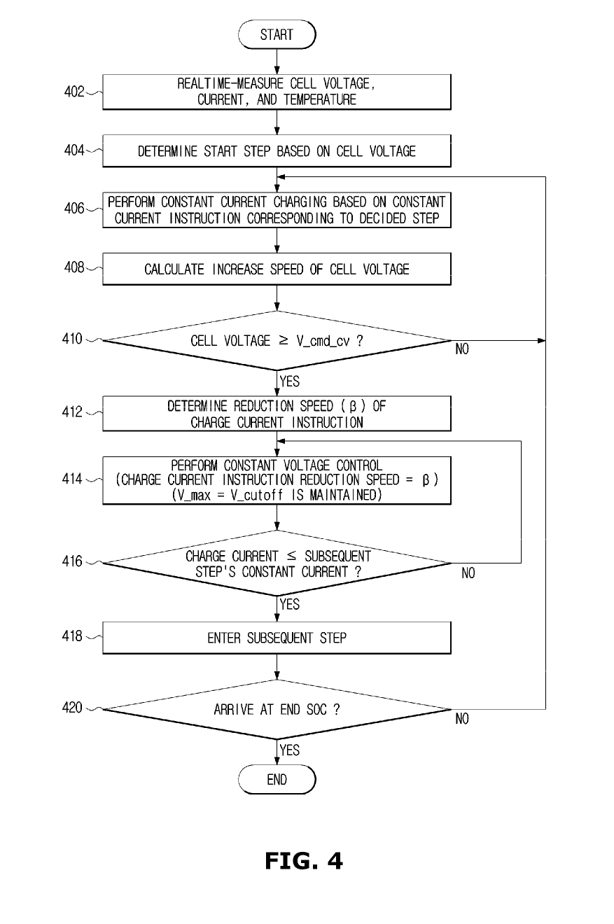

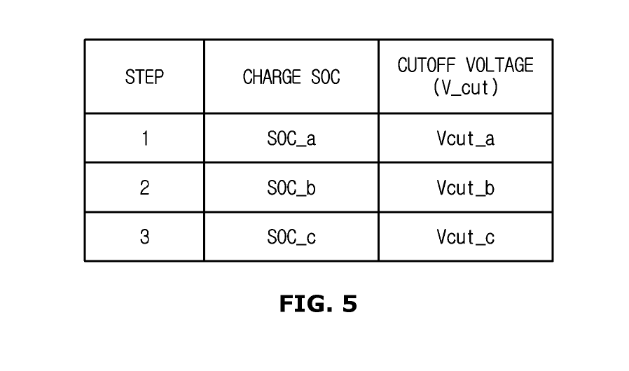

FIG. 4 is a flowchart illustrating a method for charging a battery of the electric vehicle in some forms of the present disclosure.

Referring to FIG. 4, the controller 210 may realtime-measure a cell voltage, a cell current, a cell temperature of the high-voltage battery at intervals of a predetermined time of 100 ms (402). However, the predetermined time may be changed to another time shorter or longer than 100 ms as necessary.

If the cell voltage of the high-voltage battery 102 is measured, the controller 210 may determine a step for starting charging on the basis of the measured cell voltage (404). As can be seen from FIG. 3, the controller 210 may divide a total SOC step (or section) on the basis of the cutoff voltage of the high-voltage battery 102 into a plurality of steps (sections), may charge the battery of the electric vehicle 100 using the MSCC (or MCC) scheme, and may perform charging based on a constant voltage corresponding to the predetermined cutoff SOC in each of the steps.

FIG. 5 is a table illustrating the relationship between a per-step constant current and a per-step cutoff voltage for charging a high-voltage battery of an electric vehicle in some forms of the present disclosure. Referring to FIG. 5, the cutoff voltages (Vcut) of the respective steps may include Vcut_a, Vcut_b, and Vcut_c. The charging SOCs based on the cutoff voltages (Vcut) for the respective steps may include SOC_a, SOC_b, and SOC_c.

Referring to FIG. 5, when the measured cell voltage is equal to or less than Vcut_a, the controller 210 may start charging in a condition of STEP 1. If the measure cell voltage is higher than Vcut_a and is equal to or less than Vcut_b, the controller 210 may start charging in a condition of STEP 2. If the measured cell voltage is higher than Vcut_b and is equal to or less than Vcut_c, the controller 210 may start charging in a condition of STEP 3.

Referring back to FIG. 4, if the charging start step is decided, the controller 210 may generate a constant current instruction corresponding to the decided step, and may perform constant current charging based on the constant current instruction (406).

During charging of the high-voltage battery 102 based on constant current charging, the controller 210 may calculate an increase speed of the cell voltage of the high-voltage battery 102 (408).

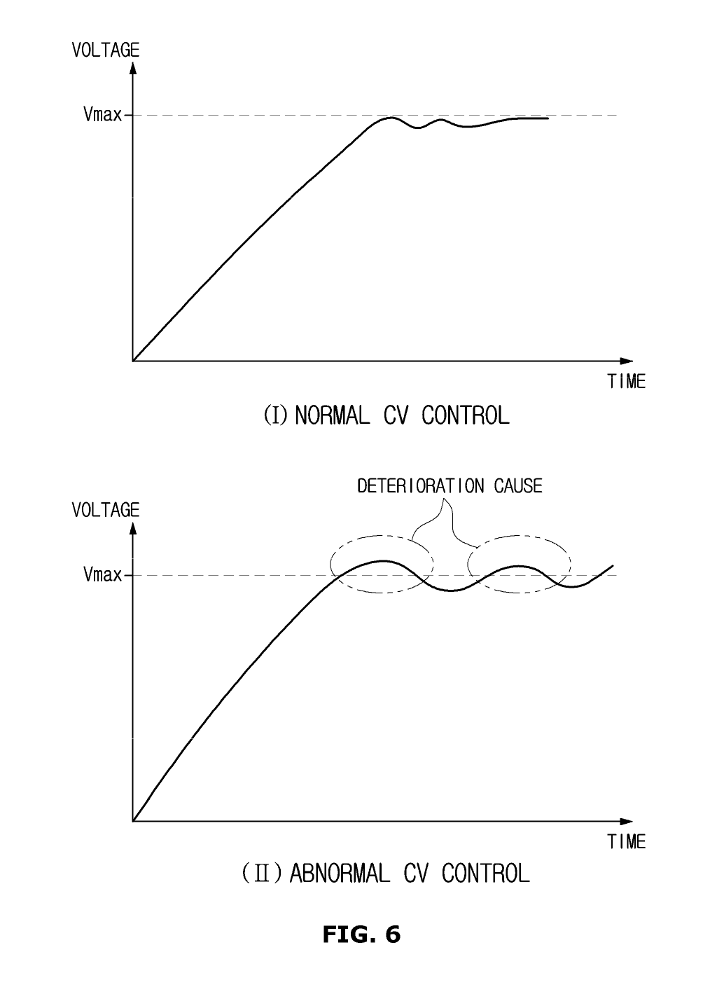

FIG. 6 is a view illustrating a normal constant-voltage charge control and an abnormal constant-voltage charge control in some forms of the present disclosure. In FIG. 6(I), the cell voltage may be normally controlled not to exceed a maximum voltage (Vmax). In constant, the cell voltage may gradually increase, such that a section in which the cell voltage exceeds the maximum voltage (Vmax) is present as shown in FIG. 6(II). In the section in which the cell voltage exceeds the maximum voltage (Vmax) as shown in FIG. 6(II), the high-voltage battery 102 may be deteriorated. Such deterioration of the high-voltage battery 102 may also deteriorate the lifespan and performance of the high-voltage battery 102. Therefore, the forms of the present disclosure may generate a reduction speed of the charge current instruction appropriate for the increase speed of the cell voltage when entering the constant voltage charging mode, such that a normal constant voltage charge control shown in FIG. 6(I) can be achieved.

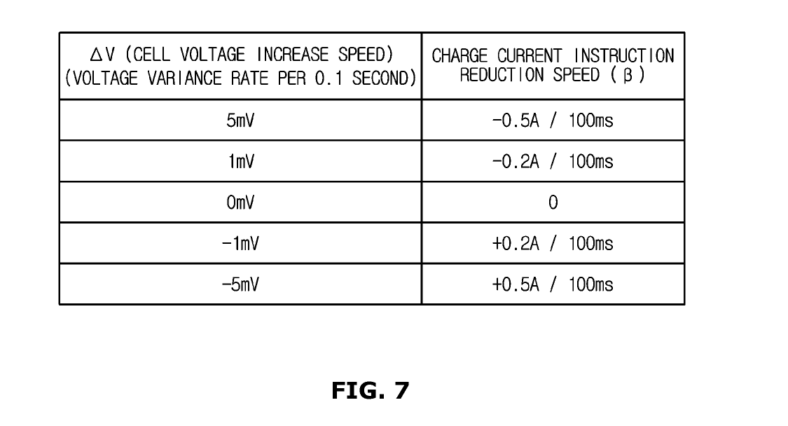

FIG. 7 is a table illustrating the relationship between an increase speed of a cell voltage and a reduction speed of a charge current instruction in some forms of the present disclosure. Referring to FIG. 7, the higher the increase speed of the cell voltage (hereinafter referred to as the cell voltage increase speed) of the high-voltage battery 102, the lower the reduction speed of the charge current instruction (hereinafter referred to as the charge current instruction reduction speed). In more detail, when the increase speed of the cell voltage is excessively high, the increase speed of the cell voltage is reduced, such that an overshoot section (battery deterioration section) as shown in FIG. 6(II) is prevented from occurring. Values shown in FIG. 7 may be acquired using experiments in consideration of current (I) response characteristics between the high-voltage battery 102 and a charger.

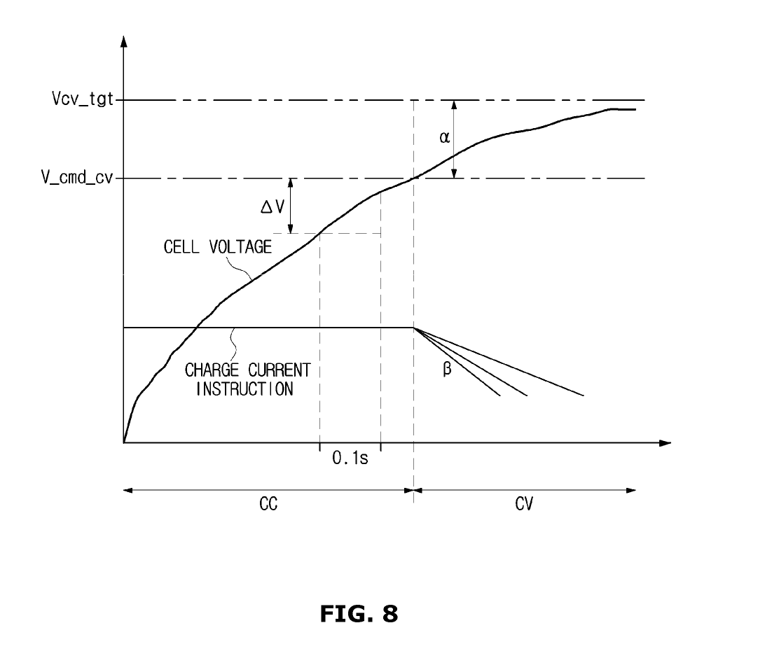

Referring back to FIG. 4, the controller 210 may determine whether the cell voltage increasing by constant current charging is equal to or higher than a voltage (V_cmd_cv) for entering constant voltage charging control (V_cmd_cv) (410). As previously described above, when the increase speed of the cell voltage is excessively high, the increase speed of the cell voltage should be reduced to prevent occurrence of the overshoot section (battery deterioration section) as shown in FIG. 6(11). To this end, when the cell voltage arrives at a specific point at which the cell voltage is lower than a target voltage (Vcv_tgt) for constant voltage charging (hereinafter referred to as a target constant voltage charge voltage Vcv_tgt) by a voltage margin (a) as shown in FIG. 8, a charge current instruction reduction speed (8) is newly decided to reduce the charge current instruction.

FIG. 8 is a graph illustrating a method for determining a reduction speed of a charge current instruction in response to an increase speed of the cell voltage using the method for charging a high-voltage battery in some forms of the present disclosure. Referring to FIG. 8, when the cell voltage arrives at a specific point at which the cell voltage is lower than the constant voltage charge target voltage (Vcv_tgt) by the voltage margin (a), the charge current instruction may be changed in a manner that the cell voltage does not exceed the target constant voltage charge voltage (Vcv_tgt). As can be seen from FIGS. 7 and 8, the higher the increase speed of the cell voltage, the lower the reduction speed of the charge current instruction, such that the increase speed of the cell voltage can be reduced. In contrast, the lower the increase speed of the cell voltage, the higher the reduction speed of the charge current instruction, such that the increase speed of the cell voltage can be increased. The reason why the charge current instruction reduction speed is regulated is to prevent occurrence of a section in which the cell voltage rapidly arriving at the target constant voltage charge voltage (Vcv_tgt) without exceeding the target constant voltage charge voltage (Vcv_tgt). In FIG. 8, the increase speed of the cell speed may be measured through a variance (ΔV) of the cell voltage during a predetermined time (e.g., 0.1 s).

Referring back to FIG. 4, when the cell voltage increases to the constant voltage charge control entry voltage (V_cmd_cv) or higher (YES in 410), the controller 210 may determine the charge current instruction reduction speed (13) in consideration of the increase speed of the cell voltage due to the same reason as described above (412).

In contrast, when the cell voltage is less than the constant voltage charge control entry voltage (NO in 410), the controller 210 may continuously perform the constant current charging operation 406.

When the charge current instruction reduction speed (8) is decided, the controller 210 may charge the high-voltage battery 102 using the constant voltage charging scheme according to the changed charge current instruction (414). In this case, the maximum voltage (V_max) may be maintained at the cutoff voltage (V_cutoff).

The controller 210 may determine whether the charge current is equal to or less than a constant current of a subsequent step (see STEPS 1 to 3 of FIG. 3) (416), such that the controller 210 may stop charging in a current step and may also decide whether to enter the subsequent step.

If the current charge current is equal to or less than a constant current of the subsequent step (YES in 416), the controller 210 may continuously perform charging of the high-voltage battery 102 when entering the subsequent step (418). If the charge current is equal to or less than the constant current during charging in STEP 1, the controller 210 may continuously perform charging of the high-voltage battery 102 in a condition of STEP 2.

If the current charge current is less than the constant current of the subsequent step (NO in 416), the controller 210 may continuously control constant voltage charging (414).

If the current SOC of the high-voltage battery 102 arrives at an end SOC (maximum SOC) by continuous charging of the high-voltage battery 102 (YES in 420), the controller 210 may stop charging of the high-voltage battery 102.

In contrast, when the current SOC of the high-voltage battery 102 does not arrive at the end SOC (maximum SOC) (NO in 420), the controller 210 may continuously perform the constant current charging operation 406.

As is apparent from the above description, a method for charging a battery of an electric vehicle in some forms of the present disclosure may prevent deterioration of the battery when charging the battery with electricity, and at the same time may improve a charging speed of the battery.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery charging method comprising:
dividing a total State of Charge (SOC) section of a battery into a plurality of steps;
performing constant current-based charging in each step of the plurality of steps; and
performing constant voltage-based charging at a predetermined voltage during the constant current-based charging for each step of the plurality of steps.

2. The battery charging method according to claim 1, wherein the method further comprises:
measuring a voltage of the battery; and
determining a charge start step among the plurality of steps based on the voltage of the battery.

3. The battery charging method of claim 1, wherein the constant current-based charging for each step of the plurality of steps is configured to follow a constant current instruction corresponding to a corresponding step.

4. The battery charging method of claim 3, wherein the method further comprises:
when a voltage of the battery charged by the constant current-based charging arrives at a predetermined voltage, changing a battery charging scheme to a constant voltage-based charging scheme.

5. The battery charging method of claim 4, wherein the method further comprises:
when the battery charging scheme is changed to the constant voltage-based charging scheme, determining a deceleration of the constant current instruction in response to a voltage acceleration of the battery based on a constant current-based charging scheme.

6. The battery charging method of claim 4, wherein the predetermined voltage is lower than a cutoff voltage of each step of the plurality of steps.

7. The battery charging method of claim 1, wherein the method further comprises:
dividing the plurality of steps based on the cutoff voltage of the battery.

8. The battery charging method of claim 1, wherein the predetermined voltage is a voltage corresponding to a predetermined cutoff SOC of the battery.

9. The battery charging method of claim 1, wherein the method further comprises:
when a charge current of the battery charged at a current step among the plurality of steps drops to a target charge current value of a subsequent step, charging at the subsequent step.

10. An electric vehicle comprising:
a motor;
a battery configured to store power to drive the motor; and
a controller configured to:
divide a total State of Charge (SOC) section of the battery into a plurality of steps;
perform constant current-based charging in each step of the plurality of steps; and
perform constant voltage-based charging at a predetermined voltage during the constant current based-charging for each step of the plurality of steps.

11. The electric vehicle of claim 10, wherein the controller is configured to:
measure a voltage of the battery; and
determine a charge start step among the plurality of steps based on the voltage of the battery.

12. The electric vehicle of claim 10, wherein the constant current-based charging for each step of the plurality of steps is configured to follow a constant current instruction corresponding to a corresponding step.

13. The electric vehicle of claim 10, wherein:
when a voltage of the battery charged by the constant current-based charging arrives at a predetermined voltage, the controller is configured to change a battery charging scheme to a constant voltage-based charging scheme.

14. The electric vehicle of claim 13, wherein:
when the battery charging scheme is changed to the constant voltage-based charging scheme, the controller is configured to determine a deceleration of the constant current instruction in response to a voltage acceleration of the battery based on a constant current-based charging scheme.

15. The electric vehicle of claim 13, wherein the predetermined voltage is lower than a cutoff voltage of each step of the plurality of steps.

16. The electric vehicle of claim 10, wherein the controller is configured to divide the plurality of steps based on the cutoff voltage of the battery.

17. The electric vehicle of claim 10, wherein the predetermined voltage is a voltage corresponding to a predetermined cutoff SOC of the battery.

18. The electric vehicle of claim 10, wherein:
when a charge current of the battery charged at a current step among the plurality of steps drops to a target charge current value of a subsequent step, the controller is configured to charge at the subsequent step.

19. A battery charging method comprising:
measuring a voltage of a battery;
dividing a total State of Charge (SOC) section of the battery into a plurality of steps;
performing constant current-based charging in each step of the plurality of steps;
determining a charge start step among the plurality of steps based on the voltage of the battery ;
performing constant voltage-based charging at a predetermined voltage during the constant current-based charging for each step of the plurality of steps; and
when a charge current of the battery charged at a current step among the plurality of steps drops to a target charge current value of a subsequent step, charging at the subsequent step.

20. A battery charging method comprising:
measuring a voltage of a battery;
dividing a total State of Charge (SOC) section of the battery into a plurality of steps based on a cutoff voltage of the battery;
performing constant current-based charging in each step of the plurality of steps;
determining a charge start step among the plurality of steps based on the voltage of the battery;
performing constant voltage-based charging at a voltage corresponding to a predetermined cutoff SOC of the battery during the constant current based charging for each step of the plurality of steps; and
when a charge current of the battery charged at a current step among the plurality of steps drops to a target charge current value of a subsequent step, charging at the subsequent step.
